(19) United States
(12) Patent Application Publication
(10) Pub. No.: US 2003/0106198 A1
(43) Pub. Date: Jun. 12, 2003

(54) Methods of making wear resistant tooling systems to be used in high temperature casting and molding

(75) Inventors: James E. Kowalczyk, Saginaw, MI (US); Rick J. Bolyea, Fraser, MI (US)

Correspondence Address: Reising Ethington Barnes Kisselle, Learman and McCulloch PC, 5291 Colony Drive North, Saginaw, MI, 48603, US

(73) Assignees: Shear Tool, Inc.; Flame Spray Coating Co., Inc.

(21) Appl. No.: 10/278,374

(22) Filed: Oct. 23, 2002

Related U.S. Application Data
(63) Continuation-in-part of application No. 09/708,929, filed on Nov. 8, 2000, now Pat. No. 6,470,550.
(60) Provisional application No. 60/350,901, filed on Oct. 29, 2001.
(60) Provisional application No. 60/164,708, filed on Nov. 11, 1999.

(51) Int. Cl. B23P 6/00; B23K 9/04

(52) U.S. Cl. 29/402.18

(57) ABSTRACT

A method of making or reconstituting a steel tooling used in the processing of high temperature molten material includes machining an undercut surface in the tooling which provides an inset edge trapping receiving surface with an end marginal wall. The undercut is prepared for the reception of a barrier layer which fills the undercut and merges with the tooling surface bordering the undercut. Then a chemical barrier providing wear resisting coating surface which is thermally expansively and contractibly compatible with the tooling surface to avoid fracturing stresses due to differential rates of thermal expansion and contraction at elevated temperatures is fused to the receiving surface.

This application claims the priority of U.S. provisional application Ser. No. 60/350,901, filed Oct. 29, 2001 and is a continuation-in-part of application Ser. No. 09/708,929, filed Nov. 8, 2000, which claims the priority of U.S. provisional application Ser. No. 60/164,708 filed Nov. 11, 1999.

This invention relates to tooling systems which are subjected to the high temperatures of molten materials in industries such as the aluminum, titanium-squeeze, and other pressure casting, vacuum casting, gravity casting or molding industries to increase the useful life of the tooling implements.

### BACKGROUND OF THE INVENTION

The tooling used in such industries is appropriately referenced as perishable tooling and includes, but is not limited to, such tooling components as bore cores, core pins, cooling jacket cores, dies, and mold cavities. Some of such tooling is virtually constantly in contact with molten metals having temperatures ranging up to 1400° F. and beyond, and the conventional steel tooling tends to rapidly corrode and erode. Extreme heat, coupled with the pressures used in the process, tend to cause rapid oxidation of the tooling and its rapid decomposition or deterioration. During the time when the corroded tooling is being removed and replaced, the machinery is down and unproductive.

Cooling of the tooling in the work environment is not a practical answer for the problem because it causes premature solidification of the metal being cast, resulting, for example, in improper filling of the molds and unacceptable castings.

While many steels have been evaluated in attempts to promote life cycle improvement for such tooling, H-13 Hot Work Die Steels have proven to be the most cost-effective material to use. The typical life of a core pin made from this material is, however less than 2000 cycles, or approximately only a period of one to two weeks in a normal production facility.

### SUMMARY OF THE INVENTION

The present method is concerned with both machining an underlying tool metal substrate to provide an undercut or isolated surface with relation to the dimensions desired, and then filling the undercut, first with a thermally compatible interface system (when required) capable of marrying a wear resistant thermally compatible coating to the metal, and finally with a thermally compatible coating which contacts the molten metal at the high temperatures of the metal. Following this, the coating is post treated in a manner to be presently described.

Chromium carbide, tungsten carbide, titanium carbide, silicon carbide, boron carbide and other materials of similar type have been employed, or are expected to be employed, as the tooling component contact surface. Cobalt chromium alloy material has been well employed as an interface or bonding layer, and other interface layers will also be identified herein.

After surface preparation, as by shot blasting and cleaning, the interface coating may be applied to the tooling component using standard plasma deposition or standard high velocity, oxygen fuel deposition (HVOF) equipment and, after the interface barrier is applied and fused to the metal, the wear resistant barrier is applied, using the same deposition system or any other suitable particulate deposition system. The surface of the wear coating is polished to provide a glass-smooth surface which is free of imperfections and has a co-efficient of friction that is as low as possible. The tooling may be post heat-treated in a manner to be described.

When components are subjected to high mechanical stresses, and the wear barrier is applied in thicker deposits, fusion of the as-sprayed deposit by furnace or flame is employed to increase the mechanical strength. This creates an atomic fused interface between the wear coating and the base tooling. When this procedure is employed, normally no bond interface barrier may be required for certain parts.

It is a principal object of the invention to provide a new technology for molten material contacting tooling of the type mentioned.

A further object of the invention is to provide tooling which has a greatly extended service life and provides tooling components which are harder, tougher, more wear resistant, and far more durable.

Still another object of the invention is to provide a method of manufacturing tooling of the character described which is far more economical to utilize, considering both the cost of replacement of the tooling and the machinery downtime which accumulates with the present day, far more frequent replacement of tooling components.

Other objects and advantages of this invention will become apparent with reference to the accompanying drawings and the accompanying descriptive matter.

### GENERAL DESCRIPTION OF THE DRAWINGS

The presently preferred embodiment of the invention is disclosed in the following description and in the accompanying drawings, wherein:

FIG. 1 is a fragmentary, sectional elevational view which shows the upper end of a molten material carrying sleeve and illustrates the entrapment of the coated material;

FIG. 2 is a fragmentary schematic sectional elevational view of a mold showing a portion of its interior contour and the manner in which the coating material is trapped;

FIG. 3 is a fragmentary, schematic, sectional elevational view illustrating an alternative manner of entrapping the coating material;

FIG. 4 is a similar fragmentary, sectional, elevational view;

FIG. 5 is a fragmentary sectional elevational view illustrating a manner of forming an outside corner on an entrapped coating;

FIG. 6 is a schematic, fragmentary, sectional, elevational view illustrating the manner in which the ends of the barrier material may be isolated and entrapped when the material is applied to the interior of a cylinder bore in which a piston or plunger travels;

FIG. 7 is a greatly enlarged, fragmentary sectional elevational view of a composite coating only;

FIG. 8 is a fragmentary schematic sectional elevational view illustrating a manner of entrapping the coating on the external wear surface of a core pin; and

FIG. 9 is a fragmentary schematic sectional elevational view illustrating another manner.

### DETAILED DESCRIPTION OF THE DRAWINGS

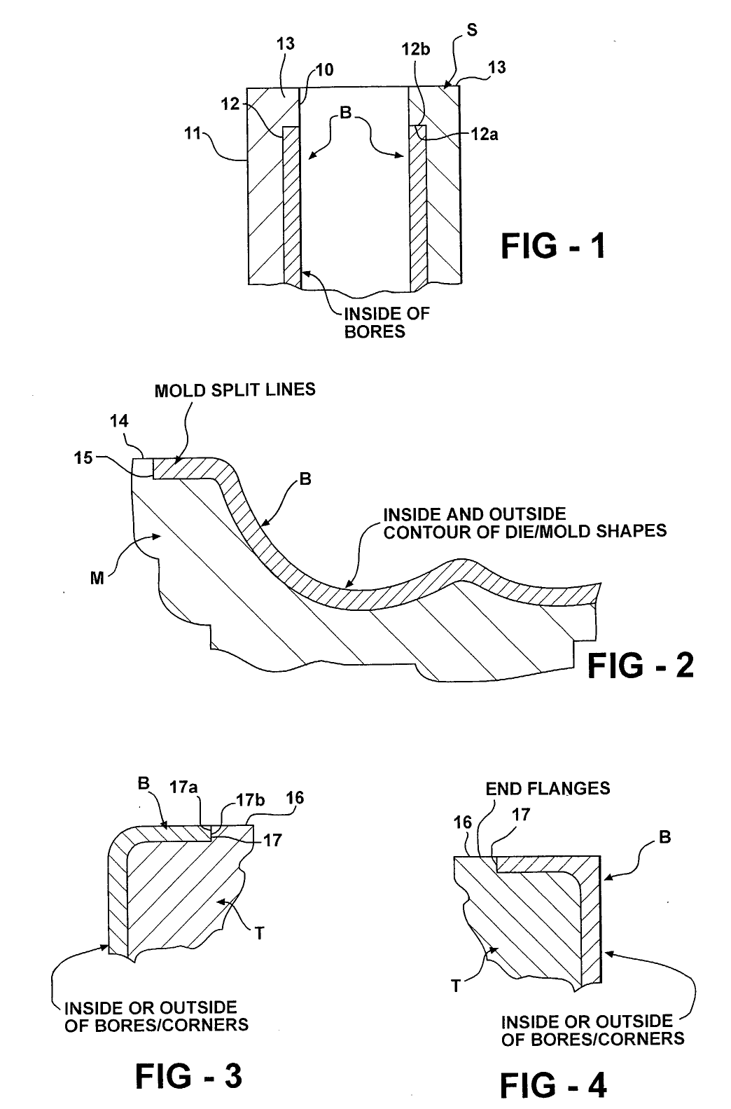

Referring now, more particularly, to the accompanying drawings, and in the first instance to FIG. 1, a sleeve, generally designated S, is schematically disclosed as having an internal annular wall 10, and an exterior wall 11. The sleeve S may be referenced broadly as a tooling member. Throughout most of its length, the interior wall 10 is circumferentially undercut or recessed as at 12 to receive a wear barrier coating, generally designated B, which will presently be more specifically described. It is to be understood that the opposite end of the sleeve S may be identical, insofar as the machining required to produce the undercut 12 in the surface 10 is concerned, and similarly takes place at a slightly spaced axial distance from the end walls 13 of the sleeve S, as shown. In this example, the ends 12a of the wear coating B are entrapped and preserved by the undercut end walls 12b to which they fuse.

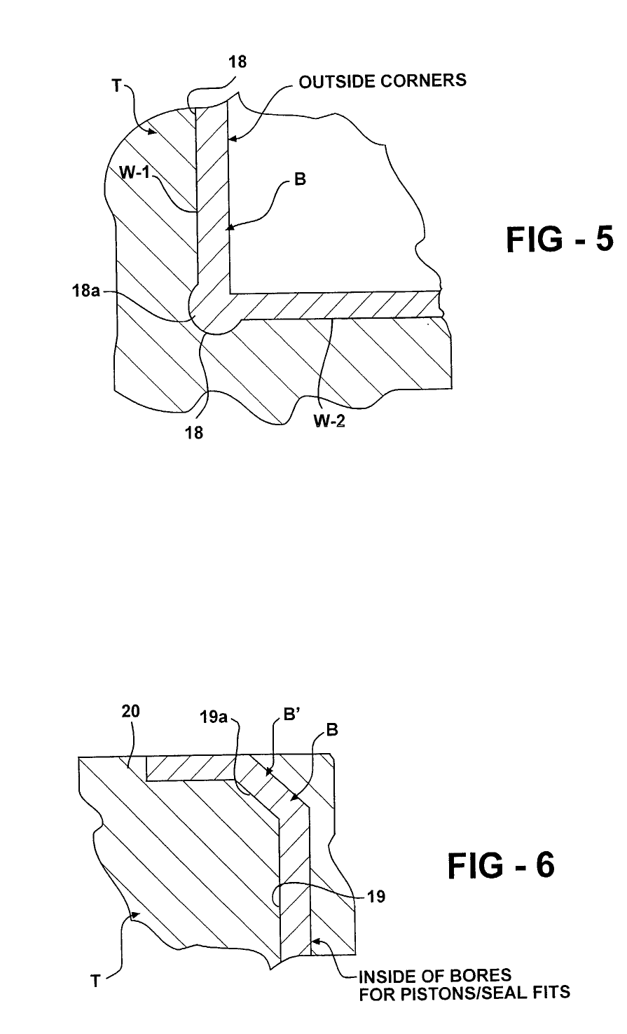

A similar result is reached in FIG. 2, which depicts a mold, generally designated M, having a mold contour surface 14, which is undercut at its perimeter as at 15 to receive the coating material B. Here the end walls 15a of the coating B are entrapped and preserved by the end walls 15b of the undercut to which they fuse. Again, the mold M may be broadly referenced as a tooling member.

Where the surface which must be protected extends the full length of the bore, as in FIGS. 3 and 4, the coating material, generally designated B, extends the full length of the bore or surface and around the end walls 16 of the tooling member which are undercut as at 17 to protect the edges of the barrier material B. The coating B not only fuses to the tooling throughout its length, the coating end walls 17a fuse to the undercut end walls 17b. FIG. 5 illustrates the outside corner of a tooling member T wherein the wall surfaces W-1 and W-2, which are undercut at their outer ends in the manner previously described, have an expanded bulged undercut 18 at their juncture. The barrier coating B which fuses to the wall surfaces W-1 and W-2 is expanded as at 18a to fill the undercut 18 and fuses to the wall surface 18.

In FIG. 6, a tooling member T, is shown as having a bore surface, generally designated 19, which at its end 20 is undercut to flare outwardly as at 19a. In this tooling component, where the bore 19 receives a piston or plunger, the outer ends of the material B are isolated, because the piston does not engage the flared portion B′ of the edge entrapped coating material which covers the flared end portion 19a and fuses to it.

In FIG. 8 a tooling member identified as a core pin includes a cylindrical pin surface 21 which is angularly undercut as at 22 to define end walls 23 and receive the barrier coating B. In FIG. 9 the undercut extends to the end of the pin and around it.

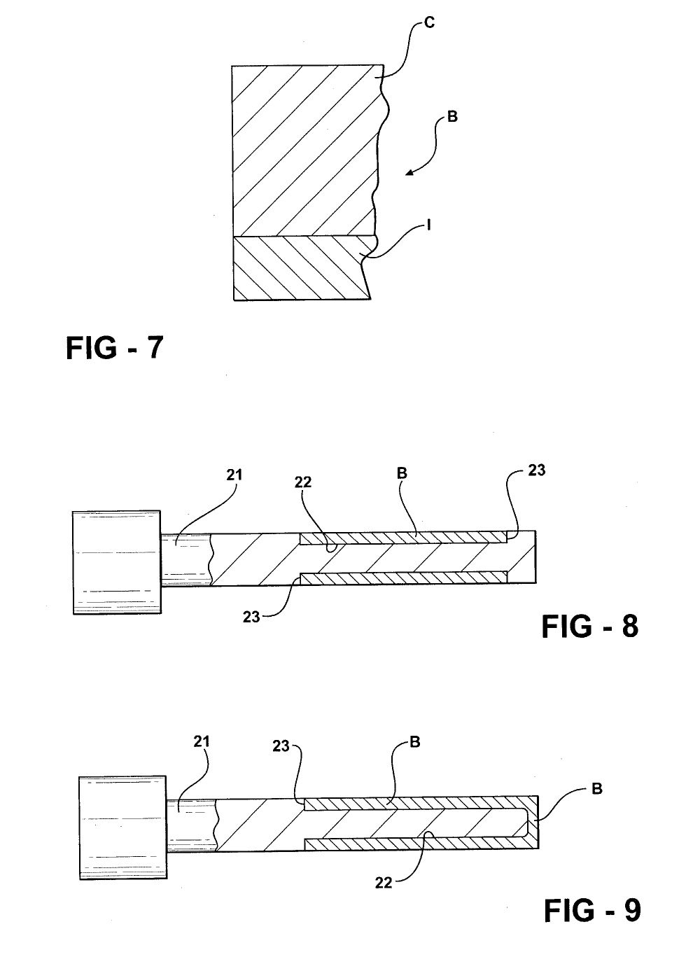

Referring now more particularly to the barrier material B in FIG. 7, it is to be understood that it may include an interface chemical barrier component I which will provide a high strength bond between the substrate surface of the metal tooling, which typically may be an H-13 hot work die steel, and an outer barrier coating C. The substrate, typically a chromium steel, which may be generally defined as having a chromium content of between 2 and 6 percent. will have a minimum hardness of 28 Rockwell C. Component I may be referenced as an interface bonding system and the coating C may be referenced as an elevated temperature wear resistant outer system layer, typically a chromium carbide or tungsten carbide. The terminology, wear resistant, can refer to abrasive wear, as when a third component is present between surfaces which rub, or adhesive wear as when two surfaces rub together and atomically bond or gall, or corrosive wear due to a chemical exposure in its use causing pitting or debonding. Tungsten carbide as coating C has superior wear resistance in the first instance and chromium carbide in the latter two. Thus, the selection between these materials depends on the tooling part and how it is used. The melting temperature of the material must be well above the temperature of use. Also, believed suitable as the outer coating C for certain uses are silicon carbide, boron carbide, and titanium carbide.

Most of the base metal tools that have the coatings applied to them are through-hardened. Typically, the most common of all the base materials to use in these processes is H-13 hot work die steel which is well known to be a vacuum degassed, air hardening, 5.25% chromium steel having lesser percentages of carbon, silicon, magnesium, molybdenum and vanadium. However, many good tool steels and die steels that are heat treatable may be used for the application of these coatings. We refer, for example, to H-11 and H-12 (also obtainable at Latrobe Steel Company of Latrobe, Pa., U.S.A. and to the Crucible Materials Corporation of Syracuse, N.Y., U.S.A.) chromium steels such as CPM9V, CPM10V, CPM1V, CPM 420V and CPM MPL-1. Another tool steel is disclosed in U.S. Pat. No. 6,280,685.

After the coatings B are applied, many of them will necessarily receive a post heat treating process. This is done to improve the non-soldering characteristic of the surface as well as adding more surface hardness and wear resistance. The conventional post treatment process we've determined can be used to cover the barrier material B is a fluid bed Ferritic Nitro carburizing (gas nitriding) heat treatment that provides a 70RC equivalent hardness to this surface of the part. This process is similar to ion nitriding, but we've found provides a casing which is less brittle and more wear resistant. However, conventional ion or gas nitriding may also be used, in some instances, as this post heat treat process step. Such gas nitriding processes are disclosed in U.S. Pat. Nos. such as 2,437,249; 2,596,981; 2,779,695; and 2,986,484 which I incorporate herein by reference. Sun Steel Treating Inc. of South Lyon, Mich., U.S.A. may be used to accomplish the Ion nitriding treatment. Dynamic Heat Treating, Inc. of Michigan may be used to accomplish the fluid bed ferritic nitro carburizing. The nitriding process leaves a film in the nature of 0.0005 of an inch on the layer C and an outer nitric oxide film of the same order as an outermost film.

In producing the illustrated tool components, the first step is to further machine the already machined parts to provide the undercut and isolated surfaces, and then to prepare the substrate surfaces to which the barrier coatings B will be applied, including the undercut end wall surfaces. This preparation may take the form of mechanically blasting the undercut and undercut end surface area with shot material such as aluminum oxide or other appropriate well known particles, and then chemically or otherwise cleaning the surface to remove any oxides or other foreign material.

The interface barrier material is then applied to these surfaces of the undercut using a commercially available plasma deposition or high velocity oxygen fuel (HVOF) deposition apparatus under the control of a computerized robotic device of commercially available character to provide a smooth fused coating I of uniform thickness and density. Then the wear resistant outer barrier component C is fused to the interface component I preferably using the HVOF process. These steps may be accomplished using the equipment and processing available at Flame Spray Coating Co. Inc. of Fraser, Mich., U.S.A. The temperature coefficients of expansion and contraction of the substrate, interface, and layer C will be substantially the same to avoid deleterious effects. The interface bonding system I absorbs any slight thermal coefficient differences between the substrate, interface, and outer wear resistant material and can be economically quite thin. The thickness for the interface layer I is approximately in the range of 0.003-0.005 of an inch, and for the outer barrier material C is 0.010 to 0.015 of an inch, or a ratio of C to I in the range of about 3 to 5 to one. In applications where the wear resistant coating is applied in a very thin layer, approximately 0.003 to 0.004 inches thick, or in very thick layers exceeding 0.015, no interface barrier material sometimes need be used. For example, using CPMIV tool steel, the barrier material may be chromium carbide without an interface binder.

An outer coating material C consisting of a 93% chromium carbide and 7% nickel chrome by weight fused to an interface material consisting of a cobalt chromium alloy comprising 64% cobalt, 29% chromium, 6% aluminum, and 1% Yttrium by weight has provided excellent results. Several core pins (as disclosed in FIGS. 8 and 9), made according to the invention, have been tested and have lasted up to ten times as long as the currently used nitrided tool steel core pins.

The cobalt chromium interface alloy I may be plasma flame sprayed or HVOF applied and fused to the underlying steel tooling with a coating density of 6.9 G/cc to have a macrohardness of about Rb 80. Both methods of deposition may be referenced as thermal spraying. It will have a porosity in volume percent of less than 1. The bond interface strength is rated between 12,000 and 14,000 p.s.i.

The outer coating C may be HVOF applied and fused with a coating density of approximately 13.6 G/cc, a tensile bond strength of 10,000-12,000 psi, a typical macrohardness of Rc 60-72 and a typical microhardness of 900-1200 DPH. It will have a porosity volume of no more than 1.0%. The oxidation resistant outer coating C, as fused, will be in the neighborhood of 150-300 micro aa and it may be machined or polished to 8-16 micro aa.

In addition to the material mentioned, the interface bonding layer I may be selected from the group comprising: Ni—17Cr—6A1—0.5Y; Ni—22Cr—10Al—1.0Y; Ni—23Cr—6Al—0.4Y; Ni—31Cr—11Al—0.6Y; Ni—23Co—20Cr8.5Al—4Ta0.6Y; Ni—20Cr—9Al—0.2Y; NiCr alloy—6Al; Ni4.5Al; Ni—17.5Cr—5.5Al—2.5Co—0.5Y; Ni—26.5Cr—7Al3.5CO—1.0Y; Ni—20Cr; Co—32Ni—21Cr—8Al—0.5Y; Co—25Cr10Ni—7Al—5Ta—0.6Y; Co—29Cr—6Al—1Y; and Co—10Ni—25Cr—3Al—5Ta—0.6Y (all by weight percent). The outer wear resistant layer may be selected from the group comprising: WC Co—80 Ni—14 Cr—4; WC Co—50 Ni—33 Cr—9; Co—44 Cr—30 W—13 Ni—13; C₃C₂—50 NiCr—50; C₃C₂—75 NiCr—25, (all also by weight percent).

Generally speaking, the method involves configuring the tooling via machining to provide protected isolated edge surfaces for each of the components of the barrier material B so that they will not be chipped or peel off due to mechanical impact or other adverse conditions which are possible, such as poor assembly procedure or minor component misalignment. The method broadly consists of preparing the surface area where the coatings I and C will be applied for particle fusing, then applying an interface bonding barrier I to the component, which is relatively thin, but may be adjusted in thickness for the material being deposited, as well as the wear resistant material being deposited upon it, and then fusing a wear resistant coating material C having non-soldering characteristics, of a thickness which will provide sufficient wear resistance, to the interface I. The term fusing is broadly used herein to mean bonding by melting or melting together.

The method may also be employed in remanufacturing tooling implements, such as spent core pins, bore cores, dies, etc., which are undercut to receive, and then provided with, the barrier coating B. The expansion and contraction characteristics (thermal coefficient of expansion) of the tool metal substrate, the interface material I, and the coating layer C are virtually the same. For H—13 steel the thermal conductivity is 0.062 cal/cm/sec/° C. at 1000° C. and the barrier components I and C are similar. The wear resistant layer C typically will be effective when exposed to temperatures up to 1400° F. which is the normal temperature reached in aluminum molding.

The unique characteristics of the chromium carbide and tungsten carbide processes have been stated by the invention to be as follows:

a) Chromium and tungsten carbides exhibit thermal conductivity and thermal co-efficients of expansion very close to the tool steels on which they are applied throughout the temperature range contemplated. They can be applied directly to hot work tool and die steels with very thin bond interface layers and they will expand and contract at similar rates with very little probability of stress fracturing at the bond interface. They will not enhance or impede the heating or cooling rate above that of steels normally used for tooling in the aluminum, pressure squeeze and static cast processes. Process-wise this is a plus as existing process technology can be utilized.

b) These materials have been shown to be highly resistant to soldering and plating from molten aluminum especially when enhanced with a post heat treat process such as ferritic nitro-carburizing which readily forms an additional resistant white oxide film at the outermost surface of the coating B.

c) These materials are resistant to chemical attacks (at the grain boundaries of the material) typically associated with hot work die and tool steels used in direct contact with aluminum at its melting temperature. While the chemical resistance has been demonstrated in operation with a high nickel chrome interface binder, and chromium carbide and tungsten carbide outer coat, it is expected that an interface binder modification to high chrome nickel will increase the life of the material via chemical resistance by several more times.

d) These materials are significant wear resistant alloys, with applied hardnesses (using the HVOF process) in the 68 to 72 Rockwell C range and wear resistance of the base material as well as corrosion resistance can be enhanced via post heat treat processes such as ion nitride and ferritic nitro carburizing.

e) Using a conventional HVOF process these materials can be applied with densities of 99.99% with no interconnecting porosity.

f) These materials are wear resistant at 1400° F. continuous operation with no significant loss of mechanical properties.

g) Worn tooling steels can be built up using the HVOF process and H-13 powdered metal, and then these barrier coatings can be applied over this properly machined new base recreating original geometry and providing a means of salvaging worn out components.

It is to be understood that other embodiments of the invention which accomplish the same function are incorporated herein within the scope of the patent claims.

We claim:

1. A method of making or reconstituting a steel tooling having a tooling surface to be used in the processing of high temperature molten material; comprising:
a) machining an undercut surface in the tooling surface which terminates at a shoulder and provides an inset edge trapping receiving surface in the tooling surface with an end marginal wall;
b) preparing said receiving surface for the reception of a barrier layer which fills the undercut and merges with said tooling surface bordering said undercut; and
c) fusing a chemical barrier providing wear resisting coating system which is thermally expansively and contractibly compatible with said tooling surface to avoid deleterious mechanical fracturing stresses due to differential rates of thermal expansion and contraction at elevated temperatures.

2. The method of claim 1 comprising fusing said system as an interface binding coating system fused to said tooling surface and an outer wear resistant coating system fused over said interface coating system.

3. The method of claim 2 wherein said interface coating has an end wall which fuses to said end marginal wall of said tooling surface and said wear resistant outer coating fuses to said end wall portion of said interface system.

4. The method of claim 2 wherein said thickness of said wear resistant outer coating system is on the order of three times the thickness of said interface coating system.

5. The method of claim 3 wherein said tooling surface is a chromium steel.

6. The method of claim 2 wherein said outer wear resisting coating system is selected from the group of chromium carbide, tungsten carbide, silicon carbide, boron carbide, and titanium carbide.

7. The method of claim 2 wherein said outer wear resistant coating system comprises a chromium carbide.

8. The method of claim 7 wherein said interface coating system comprises a cobalt chromium alloy comprising 64% cobalt, 29% chromium, 6% aluminum, and 1% Yttrium by weight.

9. The method of claim 3 wherein said interface coating is selected from the group comprising: (all by weight percent). The outer wear resistant layer may be Ni—17Cr—6A1—0.5Y; Ni—22Cr—10Al—1.0Y; Ni—23Cr—6Al—0.4Y; Ni—31Cr—11Al—0.6Y; Ni—23Co—20Cr8.5Al—4Ta0.6Y; Ni—20Cr—9Al—0.2Y; NiCr alloy—6Al; Ni4.5Al; Ni—17.5Cr—5.5Al—2.5Co—0.5Y; Ni—26.5Cr—7Al3.5CO—1.0Y; Ni—20Cr; Co—32Ni—21Cr—8Al—0.5Y; Co—25Cr10Ni—7Al—5Ta—0.6Y; Co—29Cr—6Al—1Y; and Co—10Ni—25Cr—3Al—5Ta—0.6Y (all by weight percent). The outer wear resistant layer may be selected from the group comprising: WC Co—80 Ni—14 Cr—4; WC Co—50 Ni—33 Cr—9; Co—44 Cr—30 W—13 Ni—13; C₃C₂—50 NiCr—50; C₃C₂—75 NiCr—25, all by weight percent.

10. The method of claim 1 wherein said outer wear resistant layer may be selected from the group comprising: WC Co—80 Ni—14 Cr—4; WC Co—50 Ni—33 Cr—9; Co—44 Cr—30 W—13 Ni—13; C₃C₂—50 NiCr—50; C₃C₂—75 NiCr—25, all by weight percent.

11. The method of claim 1 wherein said barrier coating is, after being fused in place, subjected to a surface hardening nitriding procedure.

12. The method of claim 11 wherein said nitriding procedure is a gas nitriding or a fluid bed ferritic nitro carburizing heat treatment.

13. The method of claim 3 wherein said outer coating system has, before heat treatment, a hardness in the neighborhood of 60 to 72 Rockwell C and a porosity by volume substantially no greater than 1%.

14. The method of claim 11 wherein said nitriding procedure provides a nitride film and a nitric oxide outer film on said outer coating system.

15. The method of claim 14 wherein said outer coating system is a nitrided chromium carbide.

16. The method of claim 1 wherein said undercut is on the order of 0.002-0.005 inches in thickness, and said wear resistant coating is applied directly to said tooling receiving surface and is in the range of 0.002-0.005 of an inch in thickness.
